(19) United States
(12) Patent Application Publication
(10) Pub. No.: US 2002/0023869 A1
(43) Pub. Date: Feb. 28, 2002

(54) Apparatus for the purification of liquids

(76) Inventor: Aleksandr Dmitrievich Remizov, Kievskaya (UA)

Correspondence Address: YOUNG & THOMPSON, 745 SOUTH 23RD STREET 2ND FLOOR, ARLINGTON, VA, 22202

(21) Appl. No.: 09/939,673

(22) Filed: Aug. 28, 2001

(30) Foreign Application Priority Data
Aug. 29, 2000 (UA) 2000085068
Feb. 28, 2001 (GB) 0104928.7

(51) Int. Cl. C02F 9/00

(52) U.S. Cl. 210/262; 210/303; 210/513; 210/521

(57) ABSTRACT

The invention is concerned with apparatus for the purification of liquids which can be used in communal, agricultural and industrial applications. The apparatus provides containment of backwashing liquid within the apparatus with subsequent purification of backwashing liquid and supply of purified liquid to the consumer. The apparatus comprises a filter with a filtering element made of, for example, floating bead material (expanded polystyrene with bead size 0.5-3.0 mm) and a filtrate discharge pipe. A pipe-type settler is positioned below the filter, and the upper ends of settler pipes are connected to a partition which separates the settler from the filter. In the upper part of settler, an interpipe working space is formed and is connected to the filter through pipes, and a pipe for the supply of liquid to be purified is connected to filter under floating bead media. A source of compressed gas (with the possibility of providing a pulsed supply) and a device for the discharge of compressed gas to the atmosphere are connected to the upper part of the settler next to the partition. In the process of contaminated liquid purification, compressed gas, for example air, arrives from its source in the upper part of settler where it accumulates. During the backwashing of the filter, the accumulated gas is discharged from the upper part of the settler through the pipe into the atmosphere. The gas becomes replaced with backwashing liquid arriving from the filter. In the process of facility operation, the backwashing liquid is expelled from the upper part of settler by the gas arriving from the compressed gas source, becomes clarified in the pipes of the settler and further purified in the filter, and then is supplied to the consumer. If the filtration cycle shortens to less than 6 hours, then a pulsed supply of compressed gas is provided. The pulses of gas pressure transform into pulses in the liquid flow, resulting in a short-term acceleration of liquid filtration through the floating bead material, and the disengagement of admixtures and their more deep penetration into the floating bead material. This leads to a prolongation of the filtration cycle and reduction in the number of backwashes over a certain period of time, and subsequently to a reduction in non-productive use of liquid.

### BACKGROUND OF THE INVENTION

The invention relates to the separation of liquid and heterogenic phases and is concerned in particular with apparatus for the purification of liquids.

Installations for the purification of liquids are successfully used in communal, agricultural and industrial applications, particularly for the purification of drinking, potable and waste waters in which contaminants are removed by filtration and biological and chemical treatments. The facility provides purification of liquids without discharge of washing effluent from the facility, wherein liquids are purified and supplied to the consumer with the aim of efficient consumption of liquids. Advantageously according to the invention, the facility can be used for purification of liquids, for example, for purification of drinking water from turbidity.

A known apparatus for the purification of water (SU 444403A) contains a pipe type tilted settler mounted at an angle of 50-70 degrees to the axis with a flake-forming chamber at its lowest part, a bead filter medium, a water tower with washing tank and piping for supply and removal of water.

Water to be purified is supplied to the apparatus, and after purification, water is further supplied to the consumer. At the filter washing, washing water containing contaminants is removed from the facility. However the fact that the washing water is not contained means that such purification and supply to the customer leads to unproductive water use and lowers the operating efficiency of the apparatus.

Another known apparatus for the purification of water (SU 1119987A) comprises such a pipe type tilted settler having a flake-forming chamber at its lower part, a bead filter medium, a water tower with washing tank and piping for the supply of water to be purified and removal of purified water and wash water. In this case the filter is positioned in the upper part of the settler, and the filter medium and flake-forming chamber medium are floating. The relationship between the average diameters of the floating beads in the flake-forming chamber and the filter is 20-40. Besides, the relationship between the diameter of the settler pipes and the average diameter of the floating beads in the filter is 15-30.

Water, mixed with reagents, is supplied to the flake-forming chamber. In this chamber, flocculation takes place and a flake-type suspension is formed. Then the water enters the pipe type tilted settler where preliminary clarification of water from large suspended particles occurs. The water flows through the floating medium of the filter where final purification of the water takes place, and then purified water is supplied to the consumer.

For the removal of contaminants accumulated in the filter medium, the purified water is sent in a counter-current down through the floating medium, expanding the floating medium and washing out contaminants. Washing water with contaminants flows into the settler and the flake-forming chamber and is removed from the facility to the outside. After that washing stops and the facility resumes purification of the water supplied for purification.

The main disadvantage of such an arrangement is that it does not envisage containment of backwash liquid inside the facility with subsequent clarification of backwash liquid in the settler and further purification by filtration along with the process of feed liquid purification. This disadvantage results in non-productive use of liquid and decreased operational efficiency.

### SUMMARY OF THE INVENTION

According to the present invention there is provided apparatus for the purification of liquids comprising a filter with a filtering element; a pipe-type settler comprising a plurality of downwardly extending pipes arranged below the filtering element; a supply pipe for the supply of liquid to be purified to the filter; a filtrate discharge pipe for the discharge of purified liquid from the apparatus; and a residue removal pipe for the removal of residue from the apparatus; wherein the upper ends of the settler pipes are connected to a partition, which separates the filter from the settler, and the settler is connected to a source of compressed gas and equipped with means for the discharge of the compressed gas.

The main object of a preferred embodiment of the invention is to develop a facility for purification of liquids, wherein new arrangements for the settler and resulting new relationships between the settler and the filter make it possible to create an interpipe working space in the upper part of the settler, which would be periodically filled with compressed air or backwashing liquid, and to force backwashing liquid to the bottom part of the settler in order to prevent consolidation of the bottom residue and to further direct backwashing liquid to the settler pipes for clarification and then to the filter for final purification, which would decrease non-productive use of liquid and therefore increase the operational efficiency of the facility.

Preferably the source of compressed gas comprises a source of a pulsed supply of gas, and the means for the release of compressed gas comprises a pipe with a vent connected to the settler next to the partition.

Due to the fact that the upper ends of the settler pipes are adjoined by a partition, which separates the filter from the settler, a new interpipe working space is created. The new interpipe working space is connected to the filter through the settler pipes. This new space can contain a volume of gas equal to the volume of backwashing liquid coming from the filter. During backwashing of the filter, the interpipe space is filled with liquid replacing compressed air which is released into the atmosphere. After backwashing, compressed air is supplied to the interpipe working space and forces out the backwashing liquid. As the compressed air is supplied at a low flow rate, the backwashing water is gradually forced out through the settler pipes over a period of time of no less than six hours, thus allowing large contaminant particles to precipitate to the bottom of the settler. When forced out the backwashing water flows up through the settler pipes, which are tilted at angle of 50-70 degrees to the horizontal, particles of 5-10 (and more) microns in size precipitate under the force of gravity in thin channels with diameters of 25-50 mm and slide down to the bottom of the settler. Furthermore clarified backwashing liquid flows to the filter for final purification and then to the consumer.

The advantage of the apparatus according to the invention is that the connection of the settler with a source of compressed gas makes it possible to supply compressed gas to the new interpipe working space at the upper part of the settler and to accumulate it there, thus forcing out the backwashing liquid. The supply of compressed gas into the interpipe working space at the upper part of the settler leads to the formation of a volume of compressed gas, equal to the volume of backwashing liquid generated during filter backwashing. When compressed gas is supplied to the interpipe working space at the upper part of the settler while this space is filled with backwashing liquid, the compressed gas facilitates expulsion of backwashing liquid leading to preliminary clarification of backwashing liquid in the settler and additional purification at the filter with further supply to the consumer.

According to one advantageous arrangement of the invention, the means for the release of compressed gas is adapted to make it possible to periodically release the accumulated gas from the settler (for example no more than once in six hours), thus changing the operational mode of the facility and creating conditions for the backwashing liquid to move within the facility and to be purified and discharged to the consumer.

In other cases, when the contaminant load in the feed liquid is high and subsequently leads to shortening of the filtration cycle to less then 6 hours, a very brief pulsed supply of compressed gas to the settler can be produced in order to increase the contaminant capturing capacity of the filter. For this purpose, pulses of compressed gas are supplied to the interpipe working space of the settler at intervals of 10-60 minutes. The pressure pulses of compressed gas are transformed to liquid flow pulses in the interpipe working space of the settler which are further transferred to the filter and the filtering element comprising, for example, floating bead material. The liquid flow pulses, transferred to the filtering element, dislodge impurities from the surfaces of the bead material and permit impurities to penetrate more deeply into the filtering element, thus prolonging the filtration cycle and reducing the number of backwashes over a period of time, for example a day.

The compressed gas release means may comprise a pipe with a valve connected to the settler next to the partition in order to make it possible to remove the whole volume of compressed gas from the interpipe working space of the settler, to change the operational mode of the facility and to regulate the speed of filtering element backwashing by regulating the speed of compressed gas removal from the settler.

These specific design features of the apparatus ensure considerably decreased non-productive use of liquid and a higher operational efficiency by comparison with known apparatus for liquid purification.

### BRIEF DESCRIPTION OF THE DRAWING

The invention is further explained by the following description of an embodiment of the invention given, by way of example, with reference to the attached drawing, in which:

FIG. 1 shows a sectional view of the apparatus in a liquid purification mode according to the present invention, and

FIG. 2 shows a sectional view of the apparatus in a filter element backwash mode according to the present invention.

### DETAILED DESCRIPTION OF THE DRAWING

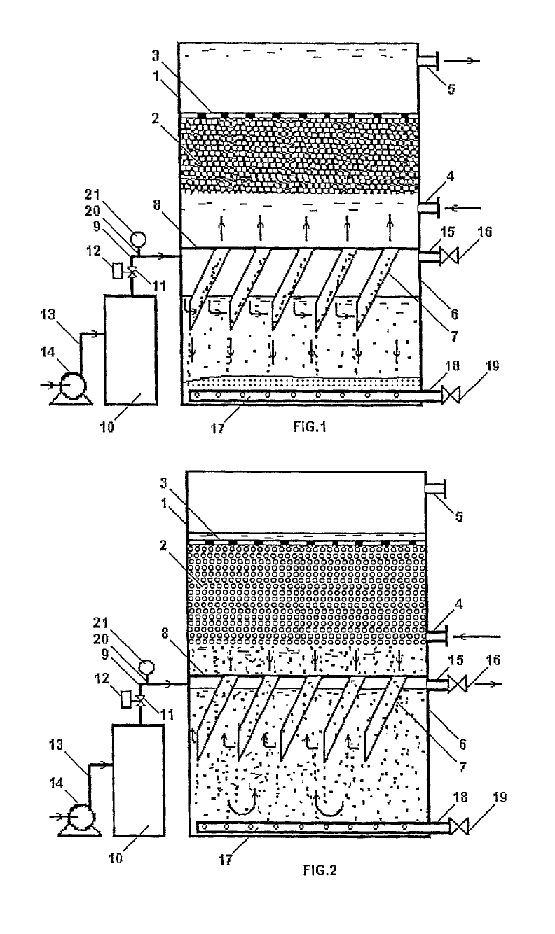

The apparatus shown in FIGS. 1 and 2 comprises a filter 1 with a filtering element made of, for example, floating bead material 2 (expanded polystyrene with bead size 0.5-3.0 mm) and held down by a net 3. A pipe 4 for the supply of feed liquid to be purified is connected to the filter 1 below the floating bead material 2, and a pipe for the removal of purified liquid is connected to the filter 1 above the floating bead material 2. A pipe-type settler 6 is positioned under the filter 1, and the upper ends of settler pipes 7 are attached to a partition 8 which separates the settler from the filter. In the upper part of the settler 6 there is an interpipe working space isolated from the filter at the top, but connected to the filter through the pipes 7 which are mounted at an angle of 50-70 degrees to the horizontal.

A pneumatic pipe 9 is connected at one end to a hermetic tank 10, and at the other end to the settler 6 next to the partition 8. The pneumatic pipe 9 has a valve 11 with an actuator 12. The tank 10 is connected by a pneumatic pipe 13 to a source of compressed air, for example a compressor 14. The settler 6 is equipped with a device for the release of compressed air comprising, for example, a pipe 15 with a valve 16. The pipe 15 is connected to the settler 6 next to the partition 8. A system of perforated pipes 17 is situated at the bottom of the settler 6 and is connected to the pipe 18 for the removal of the residue. The pipe 18 is equipped with a valve 19. A pressure gauge 21 is connected to the facility by the pneumatic pipe 9 and a pipe 20.

The apparatus operates in the following manner. The liquid to be purified is introduced through the pipe 4 into the filter 1 under the floating bead material 2 and also through the pipes 7 into the settler 6. The liquid passes through the floating bead material 2, is purified and reaches the filter space above the floating bead material 2. From there, the filtrate is removed through the pipe 5 and supplied to the consumer. Meanwhile the valves 16 and 19 are shut off, and the valve 11 is opened.

During the process of liquid purification, the compressor 14 draws in gas, for example air from the atmosphere, and then under pressure supplies it at a required rate to the upper part of the settler 6 through the pneumatic pipe 13, the hermetic tank 10 and the pneumatic pipe 9 with the open valve 11. Compressed gas accumulates in the interpipe working space, and expels liquid from the settler 6 through the pipes 7 into the filter 1 in which liquid passes through the filtering material 2 and is further supplied to the consumer. The level of liquid in the settler 6 drops to the minimum level which is 5-10 cm higher than the lower end of the settler pipes 7. This excludes the breakthrough of compressed air into the floating bead material 2 and the escape of contaminants into the filtrate.

As contaminants accumulate in the floating bead material 2 and the hydraulic resistance of the floating bead material 2 increases, the hydraulic pressure in the facility rises and is monitored by the pressure gauge 21.

As the pressure in the facility reaches a predefined value, the apparatus is switched to the mode in which the floating bead material 2 is backwashed. The valve 16 on the pipe 15 is opened, and a defined volume of compressed gas accumulated in the interpipe working space in the upper part of the settler 6 is released into the atmosphere through the pipe 15. The level of liquid in the settler 6 rises, and the facility is placed in the mode in which the floating bead material 2 is backwashed. Filtrate from the filter space is discharged downwardly and by its countercurrent motion washes out contaminants from the expanded floating bead material 2. The backwashing process lasts for 30-60 seconds. During backwashing of the filter 1, the liquid passing through the pipes 7 agitates the residue at the bottom of the settler 6 and prevents the residue from consolidating over a long period of containment (1-60 days). As liquid emerges from the pipe 15, the backwashing of the floating bead material 2 is stopped and the valve 16 on the pipe 15 is shut off.

The apparatus then switches to the liquid purification mode in which liquid enters the filter 1 through the pipe 4, previously supplied backwashing liquid remaining in the settler 6. Compressed gas is continuously supplied to the settler 6, including during the backwashing period, and due to a low flow rate of compressed gas supply, for example 0.05 m3/h for a facility with 10m3/h filtrate output, it is slowly accumulated in the interpipe space over a time period of no less than 6 hours and slowly at the rate of 0.5 m/h forces out the backwashing liquid through the pipes 7 into the filter 1. In the process of backwashing liquid movement through the pipes 7, which are tilted at an angle of 50-70 degrees to the horizontal, admixtures precipitate under gravity in the lower parts of the thin channels and slide down to the bottom of the settler 6, while clarified liquid arrives in the filter 1. In the filter 1, the clarified liquid is mixed with the feed liquid to be purified, passes through the floating bead material 2, and then is removed from the facility through the pipe 5 and supplied to the consumer.

The cycles of purification for feed liquid to be purified and backwashing liquid are repeated. After 5-200 filtration cycles, as residue accumulates at the bottom of the settler 6, the valve 19 is opened and the residue is removed from the facility through the perforated pipes 17 and the pipe 19.

In cases where the feed liquid to be purified has high levels of contaminants, the floating bead material becomes heavily loaded with contaminants. Consequently, resistance of the floating bead material builds up faster, the filtration cycle shortens to less than 6 hours, and the number of backwashes over a certain period of time rises, resulting in increased non-productive use of liquid for backwash purposes as opposed to productive supply of purified liquid to the consumer. To overcome this effect, pulsed supply of compressed gas into the facility can be provided. The actuator 12 activates the valve 11 to shut off the pneumatic pipe 9, and the gas from the compressor 14 arrives through the pneumatic pipe 13 into the hermetic tank 10, where the pressure rises to a pre-defined value. The actuator 12 activates the valve 11 to open the pneumatic pipe 9 at defined time intervals, for example 10-60 minutes. Compressed gas from the the hermetic tank 10 escapes with force through the pneumatic pipe 9 into the interpipe working space in the upper part of the settler 6.

Gas pressure pulses in the settler 6 are transformed to liquid flow pulses from the settler 6 to the filter 1, resulting in a short-term acceleration of liquid filtration through the floating bead material 2, and the disengagement of admixtures and their more deep penetration into the floating bead material 2. This facilitates an increase in the contaminant arresting capacity of the material 2, prolongation of the filtration cycle and a reduction in the number of backwashes over a certain period of time. The purification of the contaminated backwashing liquid and the backwashing of the floating bead material 2 under the conditions of pulsed supply of compressed gas to the facility occur in the same manner as in normal conditions of compressed gas supply described above.

The apparatus for the purification of liquids can be successfully used in communal, agricultural and industrial applications, particularly for the purification of drinking, potable and waste waters from contaminants by means of filtration and by biological and chemical treatment. Such apparatus for the purification of liquids can be used, for example, for the purification of drinking water from turbidity.

1. Apparatus for the purification of liquids comprising a filter with a filtering element; a pipe-type settler comprising a plurality of downwardly extending pipes arranged below the filtering element; a supply pipe for the supply of liquid to be purified to the filter; a filtrate discharge pipe for the discharge of purified liquid from the apparatus; and a residue removal pipe for the removal of residue from the apparatus; wherein the upper ends of the settler pipes are connected to a partition, which separates the filter from the settler, and the settler is connected to a source of compressed gas and equipped with means for the discharge of the compressed gas.

2. Apparatus according to claim 1, wherein the source of compressed gas is connected to the settler.

3. Apparatus according to claim 1, wherein the source of compressed gas is a supply of pulsed compressed gas.

4. Apparatus according to claim 1, wherein the means for the discharge of compressed gas comprises a pipe which incorporates a valve and is connected to the settler adjacent to the partition.
